(19) United States
(12) Patent Application Publication
(10) Pub. No.: US 2014/0123805 A1
(43) Pub. Date: May 8, 2014

(54) HANDLEBAR VIBRATION DAMPING

(71) Applicant: ONE INDUSTRIES CORP., San Diego, CA (US)

(72) Inventors: Duncan G. Robins, McKinleyville, OR (US); Rick Grossman, Granada Hills, CA (US)

(73) Assignee: ONE INDUSTRIES CORP., San Diego, CA (US)

(21) Appl. No.: 13/672,644

(22) Filed: Nov. 8, 2012

(51) Int. Cl. B62K 21/14

(52) U.S. Cl. CPC B62K 21/14
USPC 74/551.8; 29/896.91

(57) ABSTRACT

A handlebar is described, including a handlebar tube having a middle portion and two rising portions disposed on opposite sides of the middle portion. A damping device may be spaced from the middle portion and may span from one rising portion to the other rising portion, the damping device including a first member operatively connected to a second member by an articulation device. The articulation device may be configured to dampen axial movement of the first member relative to the second member.

### FIELD

This disclosure relates to hand controls for use on motorized vehicles, specifically to handlebars for use in motocross and other motorcycle-related sports.

### BACKGROUND

High frequency vibrations may cause muscles to fire continuously, resulting in fatigue. This phenomenon has been observed, for example, as rapidly deteriorating grip strength in workers operating machinery, such as power drills, vibrating at high frequencies. The effects of high frequency vibrations are also regularly experienced by riders of off-road motorcycles and similar motorized vehicles.

Grip strength is an important factor in the safe operation of a motorcycle or other vehicle. Due to the physical and dangerous nature of riding, it is imperative that operators maintain a firm grip on the handlebars. Unfortunately, due to the jarring nature of riding off-road and the vibrations created by powerful engines, the hands and forearms of riders can fatigue very quickly. This fatigue results in diminished grip strength, which causes riders to work harder for a firm grip, in turn causing further fatigue and diminished grip strength. Due to this self-perpetuating downward spiral, many riders quickly experience what is commonly called “arm pump”.

To combat fatigue-causing shocks and vibrations, shock absorbers have been developed to absorb large, jarring movements. These absorbers are often located in the front bike forks, but they can also be designed into the rear swing-arm of a bike.

### BRIEF SUMMARY

An example of handlebars constructed according to the present disclosure may include a handlebar tube having a middle portion and two rising portions disposed on opposite sides of the middle portion. A damping device may be spaced from the middle portion and may span from one rising portion to the other rising portion, the damping device including a first member operatively connected to a second member by an articulation device. The articulation device may be configured to dampen axial movement of the first member relative to the second member.

A second exemplary handlebar may include a handlebar tube having a middle portion and two rising portions disposed on opposite sides of the middle portion. A damping device may be spaced from the middle portion and may span from one rising portion to the other rising portion, the damping device including a first member having a first axial bore and a second member having a second axial bore. The second member may be spaced from and in substantial coaxial alignment with the first member. A rod may have a first end affixed in a third axial bore of the first member. A mid-portion of the rod may be disposed in the first axial bore. A second end of the rod may be disposed in the second axial bore. A flexible tube may surround a length of the rod, the flexible tube having a first end disposed in the first axial bore and a second end disposed in the second axial bore. The first, second, and third axial bores may all be coaxial, and the rod may be in sliding engagement with the flexible tube.

An exemplary method for damping vibration in a handlebar may include providing a first piece of crossbar and a second piece of crossbar, each piece having a first end attachable to a handlebar and a second end opposite the first end. A flexible sleeve may be provided having a first length. A first axial bore may be formed in the second end of the first piece of crossbar and a second axial bore may be formed in the second end of the second piece of crossbar, each axial bore having a depth less than one half of the first length of the flexible sleeve, and an inner diameter sized to accept an outer diameter of the flexible sleeve in a friction fit. A rigid rod may be attached to the second end of the first piece of crossbar such that the rigid rod is coaxial with the axial bore of the first piece of crossbar and the rigid rod may have an outer diameter corresponding to an inner diameter of the sleeve. The sleeve may be placed over the rod such that a first end of the sleeve is within the first axial bore. The second end of the second piece of crossbar may be placed over the sleeve such that a second end of the sleeve and a portion of the rod are within the second axial bore. The first ends of the two pieces of crossbar may be operatively connected to the handlebar.

### BRIEF DESCRIPTION OF THE DRAWINGS

FIG. 1 is a perspective view of an illustrative motorcycle.

FIG. 2 is a schematic diagram of an illustrative handlebar including one or more vibration damping systems.

FIG. 3 depicts an illustrative handlebar including an illustrative vibration damping device.

FIG. 4 is a sectional view of an assembled illustrative vibration damping device.

FIG. 5 is a partially exploded view of an illustrative vibration damping device.

FIG. 6 is a sectional view of a grip portion of an illustrative handlebar.

FIG. 7 is an exploded view of the grip portion shown in FIG. 6.

FIG. 8 is a block diagram of an illustrative method for damping vibration in a handlebar.

FIG. 9 is a block diagram of another illustrative method for damping vibration in a handlebar.

### DETAILED DESCRIPTION

The present disclosure provides systems and methods for damping vibration in a handlebar, including a particulate fill system for grip portions of the handlebar and an articulating damping device that spans a portion of the handlebar. Many alternatives and modifications which may or may not be expressly mentioned, are enabled, implied, and accordingly covered by the spirit of the disclosure. By way of example, the description below will largely be directed to motorcycles. However, the devices, systems, and methods described are also applicable to handlebars and handles used on all-terrain vehicles, bicycles, power tools, and any other apparatus in which vibration affects the manual interface with the hand or hands of a user.

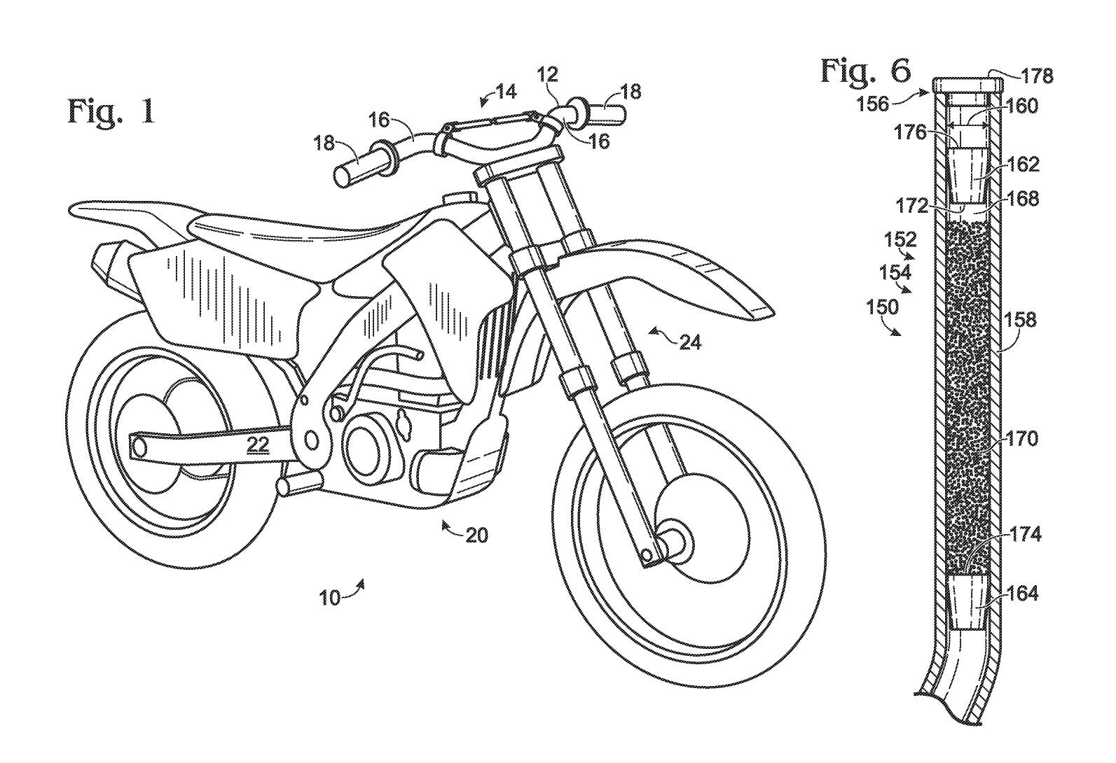

FIG. 1 shows an example of a motocross motorcycle 10 including a handlebar 12 having a vibration damping crossbar device 14 and grip portions 16. Grip portions 16 of handlebar 12 may also include hand grips 18 and additional vibration damping aspects in accordance with this disclosure as further described below. In addition to handlebar 12, motorcycle 10 may include an engine 20, a rear swing arm 22, and front shock absorber 24.

When in use, engine 20 may vibrate significantly, imparting at least some of that vibration to other components of motorcycle 10, including to handlebar 12. While the effect on a rider of large-amplitude forces may be absorbed or otherwise minimized by standard mechanisms such as rear swing arm 22 and front shock absorber 24, the higher-frequency, smaller amplitude oscillations caused by engine vibration continue to be felt by the rider. The effect of these oscillations is most notable in the handlebars, where a rider must maintain substantially constant manual contact, thereby transferring vibration to the hands and arms of the rider. Devices such as damping crossbar device 14 and others described herein are configured to reduce or mitigate this vibration.

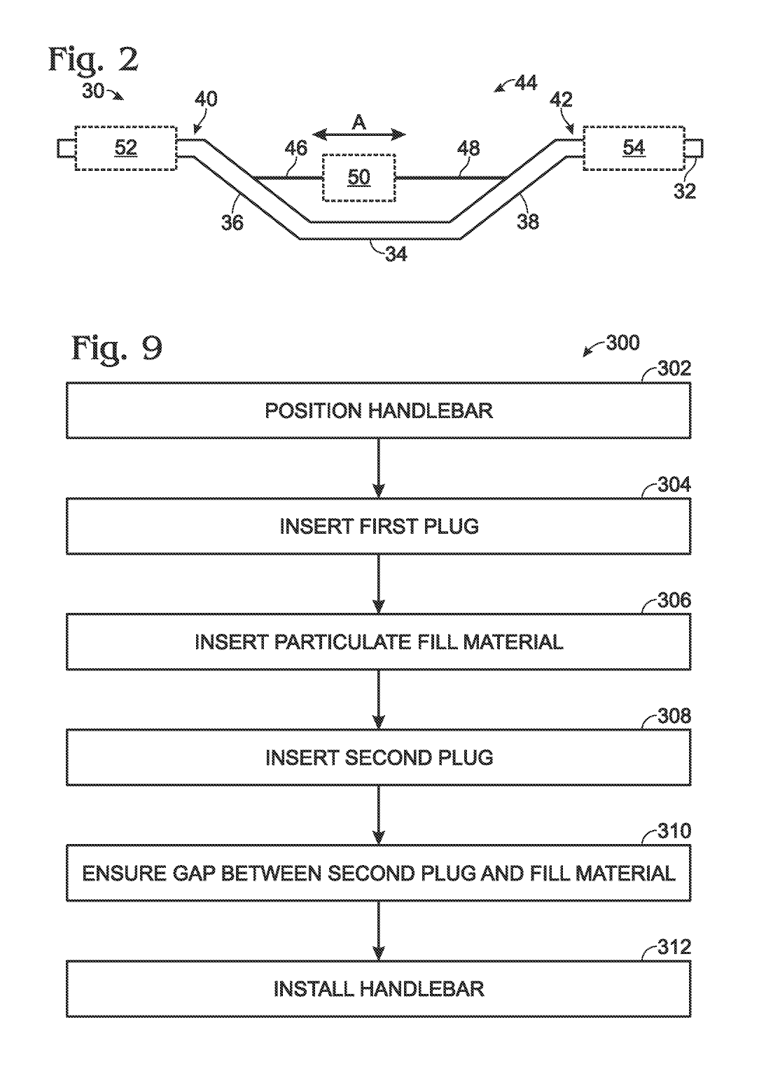

FIG. 2 shows a schematic diagram of an illustrative handlebar 30, similar to handlebar 12 of FIG. 1. Handlebar 30 may be any suitable bar configured to provide a manual interface for steering of a vehicle such as a motorcycle. For example, handlebar 30 may be a motocross handlebar, and may include a hollow tube 32 having a middle portion 34, two rising portions 36 and 38, and two grip portions 40 and 42. A damping device 44 may span from rising portion 36 to rising portion 38, spaced from middle portion 34.

Damping device 44 may be any suitable device configured to provide constrained movement in an axial direction indicated by axis A in FIG. 2. Damping device 44 may include a first member 46 operatively connected to a second member 48 by one or more articulation devices such as articulation device 50. First member 46 may be a rigid, substantially linear member attached at a first end to rising portion 36. For example, first member 46 may be a rigid rod attached to rising portion 36 using a hinged clamp. Second member 48 may be a similar rigid, linear member attached at a first end to rising portion 38. Each member may have a second end opposite the first end. First member 46 and second member 48 may each be of any suitable length configured such that the second end of each member may operatively connect to articulation device 50. For example, members 46 and 48 may be of different lengths, or may be of similar length.

Articulation device 50 may be any suitable device or devices configured to operatively connect members 46 and 48, allowing at least some relative axial motion of one member with respect to the other, while also providing a resistance or biasing against such motion. This resistance or biasing may be frictional, elastic, viscous, and/or pneumatic.

In some examples, articulation device 50 may include a sleeve configured to cover and hold the second ends of members 46 and 48 with a gap between the two members. In these examples, friction between the members and the sleeve may resist axial motion, thus damping oscillation. In other examples, articulation device 50 may include an example of a dashpot, or cylinder of viscous liquid containing a piston attached to member 46 or 48. In these examples, viscous friction may serve to dampen or cushion axial oscillation caused by vibration forces. In other examples, articulation device 50 may include a block of compressible elastic material disposed between the second ends of members 46 and 48. In these examples, the elastic block may be configured to absorb or otherwise mitigate axial vibration. In other examples, articulation device 50 may include a pneumatic shock absorber.

Articulation device 50 may be generally centered between rising portions 36 and 38. In some examples, articulation device 50 may be off-center, or may be attached directly to a rising portion 36 or 38, in which case there may be only one member 46 or 48.

Handlebar 30 may also include vibration damping devices disposed at one or both of grip portions 40 and 42. For example, a vibration damping assembly 52 may be disposed at grip portion 40, and/or a vibration damping assembly 54 may be disposed at grip portion 42. In some examples, vibration damping assemblies 52 and 54 may be larger or smaller than shown, and in some examples, the vibration damping assemblies may merge into a single assembly including the grip portions but also some or all of the rising portions and middle portion as well.

Vibration damping assemblies 52 and 54 each may include a portion of hollow tube 32 having an internal compartment filled at least partially with a particulate filler material. The particulate filler material may include any suitable particles, beads, balls, spheres, pieces, granules, grains, bodies, small objects, or other particulate members. In some examples, the filler material may be a plurality of non-elastomeric beads, such as glass beads.

The filler may include particles or beads of various sizes and shapes. In some examples, the beads may be homogeneously sized and/or shaped. For example, a filler material may include only a plurality of similar small, spherical glass beads. In other examples, larger beads may be utilized, ranging up to those with diameters proportional to the inner diameter of the hollow tube 32. The filler may also fill less than 100% of the volume of the internal compartment. In some examples, the percentage may fall within a range of about 80% to about 95%.

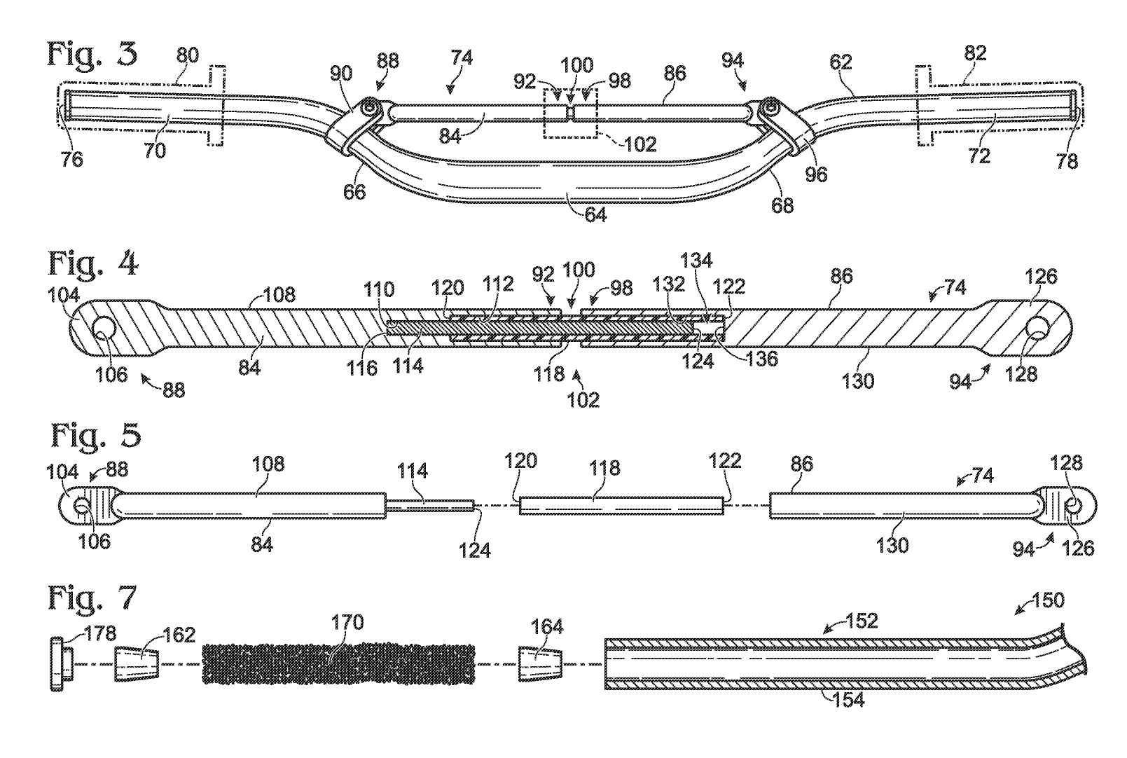

Turning to FIG. 3, an illustrative example of handlebar 30 is generally indicated at 60. Handlebar 60 may include a motorcycle handlebar tube 62 having a middle portion 64, two rising portions 66 and 68 on opposite sides of middle portion 64, and grip portions 70 and 72 on opposite ends of the handlebar tube. Handlebar 60 may also include a vibration damping crossbar device 74, which is an example of damping device 44, spanning between rising portion 66 and rising portion 68.

Grip portions 70 and 72 may include end caps 76 and 78, respectively, the end caps substantially covering the opening at each end of handlebar tube 62. Grip portions 70 and 72, as well as end caps 76 and 78, may be covered at least in part by hand grips 80 and 82, respectively, shown in phantom outline. Grip portions 70 and 72 may include illustrative vibration damping assemblies such as vibration damping assemblies 52 and 54, not shown in this view but further described below.

Middle portion 64 of handlebar 60 may be any suitable portion configured to be securely attached to a motorcycle or other vehicle for purposes of steering. Rising portions 66 and 68 may be portions of the handlebar on either side of the middle portion, forming an angle with the middle portion in order to place grip portions 70 and 72 in a more desirable position relative to the rider. Grip portions 70 and 72 are typically held by the rider in order to manipulate the handlebar and thereby steer the vehicle. Accordingly, vibration from the engine may translate through the middle and rising portions to the grip portions, where it is experienced by the rider.

This vibration may have a component or components that may be damped by a damping device oriented in parallel with the middle portion and connected to the rising portions. An example of such a damping device is vibration damping crossbar device 74. The vibration may also have a component or components that may be damped by more passive damping assemblies disposed within the handlebar itself. An example of such damping assemblies is further described below in relation to FIGS. 6 and 7.

Vibration damping crossbar device 74 may include a first member 84 and second member 86. In the example shown in FIG. 3, first member 84 is an elongate, rigid rod having a first end 88 pivotably attached to rising portion 66 by a C-shaped or U-shaped clamp 90 and a second end 92 opposite the first end. Second member 86 is a similar elongate, rigid rod having a first end 94 pivotably attached to rising portion 68 by a C-shaped or U-shaped clamp 96 and a second end 98 opposite the first end. In this example, members 84 and 86 are oriented substantially collinearly, and are sized such that a gap 100 is formed between the second ends of the two members when fully extended and at rest. Second ends 92 and 98 are operatively connected to each other by an example of articulation device 50 in the form of a sliding frictional connector 102.

Turning to FIGS. 4 and 5, more detailed views of vibration damping crossbar device 74 are shown, include first member 84, second member 86, and sliding frictional connector 102. FIG. 4 is an assembled sectional view, and FIG. 5 is a partially exploded view. First member 84 may include a flange 104 having a mounting hole 106 configured to interface with clamp 90. At least a portion of first member 84 may include a cylindrical rod 108. Rod 108 may be any suitable rigid rod made of a material such as aluminum or steel, and may include a first axial bore 110 and a second axial bore 112, both bores formed in second end 92 of first member 84. In this example, first axial bore 110 has a smaller radius than second axial bore 112, and is formed to a greater depth in second end 92 than is second axial bore 112.

A dowel or rigid pin 114 may be sized to be press-fit into first axial bore 110, and to extend beyond second end 92 of first member 84 when a first end 116 of pin 114 is fully seated in axial bore 110. Pin 114 may be made of any suitable material, and may be made of steel or aluminum. A flexible tube, sheath, or flexible sleeve 118 may be sized to fit over pin 114, having a thickness that allows sleeve 118 to also fit snugly into second axial bore 112. Flexible sleeve 118 may be any suitable sleeve configured to fit over pin 114 and into bore 112, and may include any suitable material, such as polyurethane.

When assembled, flexible sleeve 118 is in frictional contact with both an outer surface of pin 114 and an inner surface of axial bore 112. Flexible sleeve 118 has a first end 120 and a second end 122, and has a length configured to extend second end 122 of flexible sleeve 118 beyond second end 92 of first member 84, and further beyond a second end 124 of pin 114 when first end 120 of flexible sleeve 118 is fully seated in axial bore 112.

Second member 86 may include a flange 126 having a mounting hole 128 configured to interface with clamp 96. At least a portion of second member 86 may include a cylindrical rod 130. Rod 130 may be any suitable rigid rod made of a material such as aluminum or steel, and may include a first axial bore 132 formed in second end 98 of second member 86. In this example, first axial bore 132 has radius and depth similar or identical to those of second axial bore 112 formed in first member 84.

Second member 86 is arranged collinearly with first member 84, with second ends facing each other and bores 132 and 112 at least substantially aligned. Accordingly, sleeve 118 and pin 114 fit into bore 132, and second end 122 of sleeve 118 may seat fully in bore 132, leaving a gap 134 between second end 124 of pin 114 and a terminal end 136 of bore 132. Collectively, pin 114, sleeve 118, and bores 110, 112, and 132 form sliding frictional connector 102 operatively connecting first member 84 and second member 86.

Turning to FIGS. 6 and 7, an example of vibration damping assembly 52 or 54 is generally indicated at 150. FIG. 6 shows a sectional view of the assembled vibration damping assembly (VDA) 150, and FIG. 7 shows an exploded view. As described above, VDA 150 may be formed in one or more grip portions of a handlebar, such as in grip portions 70 and 72 of handlebar 60. In the example shown in FIGS. 6 and 7, a grip portion 152 may include a cylindrical tube 154 open at an end 156 and having a wall 158 and an inner diameter 160. In this example, VDA 150 includes a first barrier 162 and a second barrier 164, forming an inner chamber or compartment 168, and a plurality of filler particles 170 at least partially filling inner compartment 168.

Defining “inboard” as away from end 156 and “outboard” as toward end 156, inner compartment 168 is formed by the volume enclosed by an inboard end 172 of first barrier 162, an outboard end 174 of second barrier 164, and wall 158. Barriers 162 and 164 each may be any suitable structure configured to contain filler particles 170 within inner compartment 168. For example, barriers 162 and 164 may include walls, plugs, stoppers, blocks, or the like, or any combination thereof.

In some examples, barriers 162 and 164 may include walls formed as a unitary part of tube 154. In other examples, barriers 162 and 164 may include plugs inserted into tube 154. In some examples, inner compartment 168 may include a self-contained modular compartment having two ends and an outer wall, and the modular compartment may itself be inserted into tube 154. An outboard end 176 of barrier 162 may be spaced from end 156 to allow insertion of an end cap 178 typical of vehicle handlebars, or of any other end-mounted device desired by a user. Barriers 162 and 164 may be tapered as shown in FIGS. 6 and 7, to facilitate insertion.

As described above, in the example of FIG. 6, filler particles 170 are enclosed within inner compartment 168. Filler particles 170 may be any suitable plurality of bodies configured to interact with tube 154 and with each other to absorb vibrational energy. In some examples, filler particles 170 are non-elastomeric beads or other substantially spherical bodies having a diameter of less than approximately 0.005 inches. For example filler particles 170 may be Mil. Spec. PRF-9954 No. 12 glass beads having a diameter of 0.0025 to 0.0041 inches. In other examples, larger or smaller particles may be used. Filler particles 170 may only partially fill inner compartment 168 in order to allow movement of the particles within the compartment. For example, filler particles 170 may fill inner compartment 168 to approximately 95% as shown in FIG. 6, where tube 154 is shown vertically to allow illustration of this fill level. It is noted that filler particle size and fill percentage may be tailored or tuned to the particular style of handlebar.

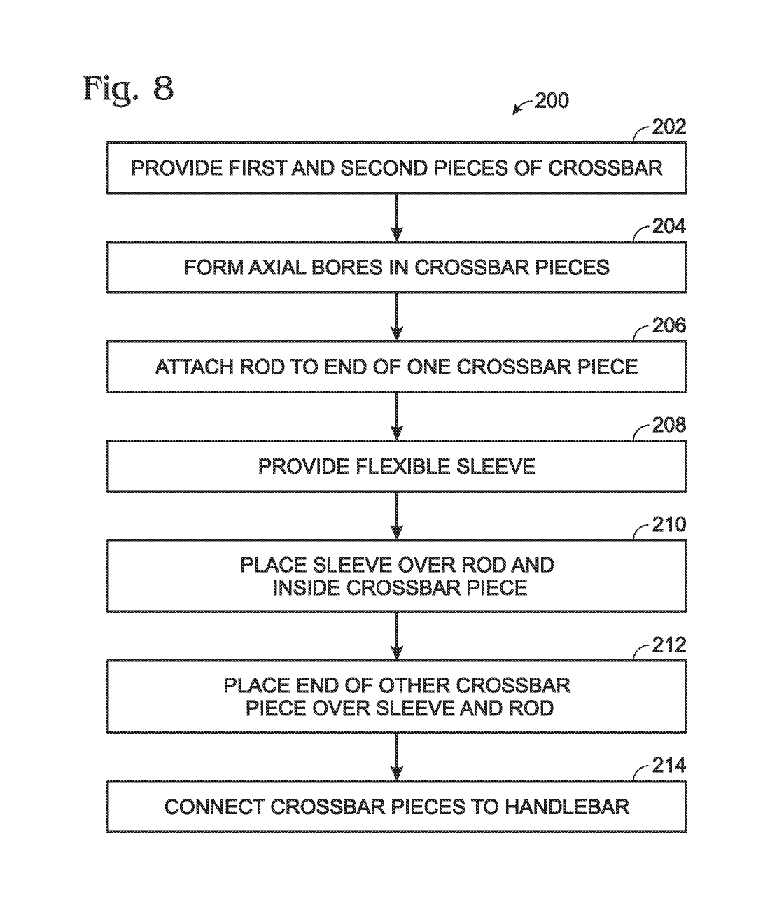

Turning to FIG. 8, an illustrative method 200 is shown for damping vibration in a handlebar. This method describes a way to provide a handlebar with an exemplary vibration damping crossbar device such as devices 14, 44, or 74.

Step 202 of method 200 may include providing a first and a second piece of crossbar, similar to the previously described first and second members. Providing these pieces may include detaching a preinstalled crossbar from the handlebar (or another handlebar), and transversely separating the crossbar into the first piece and the second piece. For example, a crossbar may be typically included on a motocross handlebar in order to provide additional strength and/or stability. This crossbar may be modified to create a vibration damping crossbar device according to this disclosure. Step 202 may include sawing or otherwise cutting the crossbar into two pieces.

Step 204 may include forming an axial bore in one end of one or both of the pieces of crossbar. The axial bores may include two coaxial bores of different diameters and depths in a first piece, and one bore in a second piece. Step 206 may include attaching a rod or pin to one end of one crossbar piece. For example, a pin may be press-fit into one of the axial bores formed in the first crossbar piece. In other examples, a pin may be affixed to the end of the piece by welding or brazing.

Step 208 may include providing a flexible sleeve or tube sized to fit over the pin of step 206. In some examples, the flexible sleeve may be made of rubber or polyurethane. Step 210 may include placing the flexible sleeve over the pin. If the pin was press-fitted into a first one of two axial bores of the first piece, the sleeve may also be sized to fit within the second axial bore, thereby placing a portion of the sleeve between the pin and the inner diameter of the axial bore. Step 212 may include placing the end of the second piece of crossbar over the sleeve and pin such that the sleeve and pin fit into the axial bore of the second piece, thereby operatively connecting the two pieces of crossbar. Step 214 may include connecting or reconnecting the assembled pieces to the handlebar. For example, this may be done using clamps or the original mounting hardware if the crossbar was detached from the handlebar (or another handlebar) in step 202.

Turning to FIG. 9, an illustrative method 300 is shown for damping vibration in a handlebar. This method describes a way to provide a handlebar with an exemplary vibration damping assembly such as VDAs 52, 54, and 150.

Step 302 of method 300 may include positioning a handlebar to facilitate the steps that follow. For example, the handlebar may be positioned such that the grip portion of the handlebar is vertical, with the opening of the end of the handlebar facing upward to receive filler material. Positioning may be accomplished by any suitable method, such as by placing the handlebar in a vise or other clamping apparatus.

Step 304 may include inserting a first barrier or plug into the handlebar tube. For example, a tapered plug may be inserted into the tube to a depth of approximately 6.5 inches as measured from the end of the tube to the outboard side of the plug. The plug may be held in place by friction, or may be glued, welded, or otherwise affixed. Step 306 may include inserting filler material into the tube. For example, a plurality of non-elastomeric particles may be inserted into the tube, filling the tube from the outboard side of the first barrier to a depth of approximately 1.75 inches below the end of the tube. In other words, a column of filler material may be formed having a length of approximately 4.75 inches.

Step 308 may include inserting a second barrier or plug into the handlebar tube. For example, a tapered plug may be inserted into the tube to a depth of approximately 0.75 inches as measured from the end of the tube to the outboard side of the plug. As in step 304, the plug may be held in place by friction, or may be glued, welded, or otherwise affixed. Step 310 may include ensuring a gap remains between the inboard side of the second plug and the filler material. For example, an inner compartment formed between the first and second barriers may have a length of approximately five inches. This may facilitate adequate movement of the filler particles as they absorb vibration of the handlebar. Step 312 may include installing or reinstalling the handlebar onto a suitable vehicle.

The following examples and embodiments should be apparent from the preceding description:

In a first example, a handlebar may include a handlebar tube having a middle portion and two rising portions disposed on opposite sides of the middle portion. A damping device may be spaced from the middle portion and may span from one rising portion to the other rising portion, the damping device including a first member operatively connected to a second member by an articulation device. The articulation device may be configured to dampen axial movement of the first member relative to the second member.

The first and second members each may have a respective first end pivotably connected to the handlebar tube and a respective second end operatively connected to the articulation device.

The first and second members may have respective first ends connected to the handlebar tube. The articulation device may include a gap between respective second ends of the first and second members. A sliding frictional connector may bridge the gap. The frictional connector may include a rigid rod coaxially affixed to the first member and a flexible sheath surrounding a length of the rod, the rod and sheath together forming an assembly configured to slidably fit within an axial bore of the second member.

The articulation device may include a spring. The spring may include an elastically compressible connector. The spring may include a dashpot.

The handlebar may further include two grip portions at opposite ends of the handlebar, each grip portion including an internal compartment containing a filler material. The filler material may include a plurality of non-elastomeric particles. The filler material may include substantially spherical beads. The substantially spherical beads may include glass beads having a diameter less than about 0.005 inches.

A second exemplary handlebar may include a handlebar tube having a middle portion and two rising portions disposed on opposite sides of the middle portion. A damping device may be spaced from the middle portion and may span from one rising portion to the other rising portion, the damping device including a first member having a first axial bore and a second member having a second axial bore. The second member may be spaced from and in substantial coaxial alignment with the first member. A rod may have a first end affixed in a third axial bore of the first member. A mid-portion of the rod may be disposed in the first axial bore. A second end of the rod may be disposed in the second axial bore. A flexible tube may surround a length of the rod, the flexible tube having a first end disposed in the first axial bore and a second end disposed in the second axial bore. The first, second, and third axial bores may all be coaxial, and the rod may be in sliding engagement with the flexible tube.

The rod may include a steel dowel pin.

The flexible tube may include polyurethane.

The first and second members may each have a respective first end pivotably clamped to the handlebar. A gap may be included between respective second ends of the first and second members, and the flexible tube and the rod may span the gap.

The first member may have a cylindrical portion having an overall axial length, and a first depth of the first axial bore may extend less than the overall axial length.

Another exemplary handlebar may include a handlebar tube having a midpoint, a first end, a second end opposite the first end, and a tubular grip portion at the first end. The tubular grip portion may have an internal compartment. A plurality of beads may at least partially fill the internal compartment of the tubular grip portion. The plurality of beads may consist only of non-elastomeric beads.

The internal compartment may be defined by a wall of the tubular grip portion, a first plug disposed inside the tubular grip portion proximate the first end, and a second plug spaced from the first plug inside the tubular grip portion toward the middle portion of the handlebar.

The plurality of beads may include substantially spherical glass beads. The substantially spherical glass beads may include beads having a diameter of less than 0.005 inches.

The first plug of the internal compartment may be spaced from the first end of the handlebar tube. The first plug may be spaced from the first end of the handlebar tube by approximately 0.75 inches.

The internal compartment may have an internal length of approximately five inches. The plurality of beads may fill approximately 95% of a volume of the internal compartment.

An exemplary method for damping vibration in a handlebar may include providing a first piece of crossbar and a second piece of crossbar, each piece having a first end attachable to a handlebar and a second end opposite the first end. A flexible sleeve may be provided having a first length. A first axial bore may be formed in the second end of the first piece of crossbar and a second axial bore may be formed in the second end of the second piece of crossbar, each axial bore having a depth less than one half of the first length of the flexible sleeve, and an inner diameter sized to accept an outer diameter of the flexible sleeve in a friction fit. A rigid rod may be attached to the second end of the first piece of crossbar such that the rigid rod is coaxial with the axial bore of the first piece of crossbar and the rigid rod may have an outer diameter corresponding to an inner diameter of the sleeve. The sleeve may be placed over the rod such that a first end of the sleeve is within the first axial bore. The second end of the second piece of crossbar may be placed over the sleeve such that a second end of the sleeve and a portion of the rod are within the second axial bore. The first ends of the two pieces of crossbar may be operatively connected to the handlebar.

Attaching the rod to the first piece of crossbar may include forming a third coaxial bore in the second end of the first piece of crossbar, the third coaxial bore having a diameter smaller than a diameter of the first coaxial bore and configured to receive the rod in a press fit. Attaching the rod to the first piece of crossbar may include pressing the rod into the third axial bore.

Providing the first and second pieces of crossbar may include detaching a preinstalled crossbar from the handlebar. The crossbar may be transversely separated into the first piece and the second piece.

Another method for damping vibration in a handlebar may include positioning a handlebar such that one end of the handlebar is open and oriented to receive material without spilling said material out of the end. A first plug may be inserted into the end of the handlebar to a first depth. A particulate fill material may be inserted into the end of the handlebar to a second depth. A second plug may be inserted into the end of the handlebar to a third depth, the third depth being less than the second depth. A gap may be ensured between the second plug and the fill material. The handlebar may be installed on a motorized vehicle.

The first depth may be approximately 6.5 inches.

The third depth may be approximately 0.75 inches.

The particulate fill material may include spherical glass beads. The spherical glass beads may include beads having a diameter of less than approximately 0.005 inches.

Although the present disclosure has been provided with reference to the foregoing operational principles and embodiments, it will be apparent to those skilled in the art that various changes in form and detail may be made without departing from the spirit and scope of the disclosure. The present disclosure is intended to embrace all such alternatives, modifications and variances. Where the disclosure recites “a,” “a first,” or “another” element, or the equivalent thereof, it should be interpreted to include one or more such elements, neither requiring nor excluding two or more such elements. Furthermore, any aspect shown or described with reference to a particular embodiment should be interpreted to be compatible with any other embodiment, alternative, modification, or variation.

What is claimed is:

1. A handlebar comprising
a handlebar tube having a middle portion and two rising portions disposed on opposite sides of the middle portion;
a damping device spaced from the middle portion and spanning from one rising portion to the other rising portion, the damping device including a first member operatively connected to a second member by an articulation device,
wherein the articulation device is configured to dampen axial movement of the first member relative to the second member.

2. The handlebar of claim 1, wherein the first and second members each have a respective first end pivotably connected to the handlebar tube and a respective second end operatively connected to the articulation device.

3. The handlebar of claim 1, the first and second members having respective first ends connected to the handlebar tube, wherein the articulation device includes a gap between respective second ends of the first and second members, and a sliding frictional connector bridging the gap.

4. The handlebar of claim 3, wherein the frictional connector includes a rigid rod coaxially affixed to the first member and a flexible sheath surrounding a length of the rod, the rod and sheath together forming an assembly configured to slidably fit within an axial bore of the second member.

5. The handlebar of claim 1, wherein the articulation device includes a spring.

6. The handlebar of claim 5, wherein the spring includes an elastically compressible connector.

7. The handlebar of claim 5, wherein the spring includes a dashpot.

8. The handlebar of claim 1, further including two grip portions at opposite ends of the handlebar, each grip portion including an internal compartment containing a filler material.

9. The handlebar of claim 8, wherein the filler material comprises a plurality of non-elastomeric particles.

10. The handlebar of claim 9, wherein the filler material comprises substantially spherical beads.

11. A handlebar comprising
a handlebar tube having a middle portion and two rising portions disposed on opposite sides of the middle portion;
a damping device spaced from the middle portion and spanning from one rising portion to the other rising portion, the damping device including a first member having a first axial bore, a second member having a second axial bore, the second member spaced from and in substantial coaxial alignment with the first member, a rod having a first end affixed in a third axial bore of the first member, a mid-portion disposed in the first axial bore, and a second end disposed in the second axial bore, and a flexible tube surrounding a length of the rod, the flexible tube having a first end disposed in the first axial bore and a second end disposed in the second axial bore;
wherein the first, second, and third axial bores are all coaxial, and the rod is in sliding engagement with the flexible tube.

12. The handlebar of claim 11, wherein the rod comprises a steel dowel pin.

13. The handlebar of claim 11, wherein the flexible tube comprises polyurethane.

14. The handlebar of claim 11, the first and second members each having a respective first end pivotably clamped to the handlebar.

15. The handlebar of claim 14, further comprising a gap between respective second ends of the first and second members, wherein the flexible tube and the rod span the gap.

16. The handlebar of claim 11, wherein the first member has a cylindrical portion having an overall axial length, and a first depth of the first axial bore extends less than the overall axial length.

17. A method for damping vibration in a handlebar, the method comprising:
providing a first piece of crossbar and a second piece of crossbar, each piece having a first end attachable to a handlebar and a second end opposite the first end;
providing a flexible sleeve having a first length;
forming a first axial bore in the second end of the first piece of crossbar and a second axial bore in the second end of the second piece of crossbar, each axial bore having a depth less than one half of the first length of the flexible sleeve, and an inner diameter sized to accept an outer diameter of the flexible sleeve in a friction fit;
attaching a rigid rod to the second end of the first piece of crossbar such that the rigid rod is coaxial with the axial bore of the first piece of crossbar and the rigid rod has an outer diameter corresponding to an inner diameter of the sleeve;
placing the sleeve over the rod such that a first end of the sleeve is within the first axial bore;
placing the second end of the second piece of crossbar over the sleeve such that a second end of the sleeve and a portion of the rod are within the second axial bore; and
connecting the first ends of the two pieces of crossbar to the handlebar.

18. The method of claim 17, wherein attaching the rod to the first piece of crossbar includes forming a third coaxial bore in the second end of the first piece of crossbar, the third coaxial bore having a diameter smaller than a diameter of the first coaxial bore and configured to receive the rod in a press fit.

19. The method of claim 18, wherein attaching the rod to the first piece of crossbar includes pressing the rod into the third axial bore.

20. The method of claim 17, wherein providing the first and second pieces of crossbar includes detaching a preinstalled crossbar from the handlebar; and transversely separating the crossbar into the first piece and the second piece.
